(19) United States
(12) Patent Application Publication
(10) Pub. No.: US 2010/0040510 A1
(43) Pub. Date: Feb. 18, 2010

(54) METHOD FOR CONVERTING BIOMASS INTO SYNTHESIS GAS USING A PRESSURIZED MULTI-STAGE PROGRESSIVELY EXPANDING FLUIDIZED BED GASIFIER FOLLOWED BY AN OXYBLOWN AUTOTHERMAL REFORMER TO REDUCE METHANE AND TARS

(76) Inventors: Sarabjit S. Randhava, Evanston, IL (US); Richard L. Kao, Northbrook, IL (US); Todd Harvey, Schaumburg, IL (US); Ajaib S. Randhava, Streamwood, IL (US); Surjit S. Randhava, Evanston, IL (US)

Correspondence Address: WILSON, SONSINI, GOODRICH & ROSATI, 650 PAGE MILL ROAD, PALO ALTO, CA, 94304-1050, US

(21) Appl. No.: 12/543,461

(22) Filed: Aug. 18, 2009

Related U.S. Application Data
(60) Provisional application No. 61/089,869, filed on Aug. 18, 2008.
(60) Provisional application No. 61/170,494, filed on Apr. 17, 2009.

(51) Int. Cl. B01J 8/18; B01J 8/20

(52) U.S. Cl. 422/140; 422/139; 422/232

(57) ABSTRACT

The invention provides systems and methods for converting biomass into syngas using a pressurized multi-stage progressively expanding fluidized bed gasifier to eliminate or reduce the formation of methane, volatiles such as BTX, and tars. The gasifier may include a reactive stage that may receive a biomass feed through a feed line and oxygen through an oxygen feed line. The gasifier may also include a fluidized bed section that may be configured to receive the reaction products from the first stage, mix them and perform fluidized bed activity. A gasifier may also have a disengagement section that may be configured to separate fluidized media and particulate matter from syngas product. A gasification system may also include oxyblown catalytic autothermal reactor and a cryogenic air separation unit.

The application claims the benefit of U.S. Provisional Application No. 61/089,869, filed Aug. 18, 2008, and U.S. Provisional Application No. 61/170,494, filed Apr. 17, 2009, which are hereby incorporated herein by reference in their entirety.

### BACKGROUND OF THE INVENTION

According to the United States Department of Energy (USDOE), this half-decade (2005-2010) will see continued growth in the gasification industry. Worldwide capacity by 2010 is projected to exceed 70,000 MWth of syngas output from 155 plants and 451 gasifiers. The USDOE study indicates that many of the gasification plants being planned will select high temperature, oxygen-blown, slagging entrained gasifiers—such as those supplied by Shell, GE Energy, ConocoPhillips, and others. By 2010, it is predicted that Shell gasifiers will account for 43% of the total world market, Sasol Lurgi will slip to a share of 27%, and GE Energy gasifiers will decline to 24% of the world market.

In terms of a near future (2010) snapshot estimation of feedstock choices, coal will continue to maintain its lead, followed closely by petroleum (including fuel oil, refinery residue, naphtha, etc.) and natural gas. Biomass is expected to account for appr. 2-3% of the syngas produced in 2010, but this number is projected to grow to 4-5% by 2015.

Industrial level gasification of biomass is a relatively new practice. Most of this activity involves air blown gasifiers to make low BTU gas for steam boilers applications. A limited amount of biomass conversion is being done with oxyblown gasifiers to make a synthesis gas (syngas) fuel for turbines. In both cases, the objective of the process is to increase the methane content in the end product, thereby achieving a proportionately higher heating value.

In accordance with one aspect of the invention, one goal in biomass gasification may be the exact opposite of the above—the goal may be to reduce the amount of methane in a synthesis gas (syngas), thereby creating a more desirable starting point for manufacturing other chemicals such as ammonia, dimethylether, methanol, etc. In these cases, methane may be a co-product of lesser abundance, and in some cases may generate significant inefficiencies in the chemical conversion process.

Attempts at shoehorning existing gasifiers may not meet the desired objectives. Thus, a need exists for a new gasifier that may increase the conversion of biomass into syngas that contains reduced amounts of methane, volatiles such as BTX, and tars.

### SUMMARY OF THE INVENTION

The invention provides systems and methods for converting a biomass into a synthesis gas (syngas). Various aspects of the invention described herein may be applied to any of the particular applications set forth below or for any other types of syngas production or other products from biomass. The invention may be applied as a standalone system or method, or as part of an integrated system, such as a gasifier, biomass gasification system, or any other system utilizing products from a gasification system. It shall be understood that different aspects of the invention can be appreciated individually, collectively, or in combination with each other.

This invention provides a new method and process for converting biomass into syngas, a mixture of gases that can include hydrogen (H₂) and carbon monoxide (CO), wherein the levels of methane (CH₄), volatiles and tars may be reduced in the composition of the end product.

The input streams fed into the gasifier may include field dried biomass (5-25% intrinsic moisture content), and controlled amounts of oxygen (O₂), steam (H₂O) and carbon dioxide (CO₂) if required.

The gasification may be conducted in a pressurized environment (e.g., 15-300 psig), and can make use of a fluidized bed reactor that may feature progressively expanding beds with enabling transition zones, whereby the three-zone geometry of the gasifier, combined with several other novel chemical and mechanical design embodiments, may optimize the residence time within each zone, and may facilitate the kinetics of the underlying chemical reactions to yield the desired gas product. Depending upon location, temperatures within the gasifier can range from 1,450° F. to 2,000° F.

The biomass may be injected deep into the lowest section of the fluidized bed gasifier, such that the methane, tars and other volatile components that are generated may be converted into their various equilibrium components.

This invention demonstrates a proposed method that, in some embodiments, may be energy neutral, and may not require any external/additional energy resources to enable sustained operation.

Finally, this invention may offer a significant benefit in terms of carbon management and sequestration. The gasifier may be deliberately operated in a substoichiometeric mode that can leave 2-10% of the biomass feedstock in the form of a highly valuable biochar and inorganic mineral ash mixture, which when recovered, can be sold and recycled as a premium fertilizer and soil enhancement agent.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows a gasifier and gasification system in accordance with an embodiment of the invention.

FIG. 2 shows results of an analysis that looks at bed diameters as a function of superficial velocity for different pressure ranges for a reactive stage.

FIG. 3 shows results of an analysis that looks at bed diameters as a function of superficial velocity for different pressure ranges for a fluidization stage.

FIG. 4 is a plot showing correlation of some experimental values of the angle of free jet expansion (O), obtained when operating with a ratio Do/Dp smaller than 7.5, against a defined two-phase Froude number.

FIG. 5 shows an example of an autothermal reforming process.

FIG. 6 shows an effect that increasing oxygen feed may have on the concentration of H₂, CO and CH₄ in the effluent gas and upon the effluent gas temperature from an autothermal reformer.

FIG. 7 shows an effect of increasing oxygen feed on the total moles of H₂, CO and CH₄ in a system.

FIG. 8 shows an example of ammonia synthesis from a corn cob biomass feed with 10 wt % moisture.

FIG. 9 shows an input and an output from a gasifier from a corn cob biomass feed with 10 wt % moisture.

FIG. 10 shows an example of ammonia synthesis from a corn cob biomass feed with 23 wt % moisture.

FIG. 11 shows an input and an output from a gasifier from a corn cob biomass feed with 23 wt % moisture.

FIG. 12 shows a possible gasifier geometry that may be used for an ammonia synthesis application.

### DETAILED DESCRIPTION OF THE INVENTION

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

The invention provides systems and methods for converting biomass into syngas using a pressurized multi-stage progressively expanding fluidized bed gasifier to eliminate, minimize or reduce the formation of methane, volatiles and tars. The fluidized bed may contain a fluidizing medium that may range from sand to olivine particles. Olivine has the additional benefit of being able to convert a significant amount of tars into syngas.

This invention also discloses the use of an oxyblown autothermal reformer downstream of the gasifier. In this oxyblown autothermal reformer, any residual tars and benzene, toluene and xylenes that are still present in the hot gases may be reformed into additional syngas. The autothermal reformer may also convert most of the methane present in the gasifier effluent stream into additional syngas. This reformer may enable the maintenance of high syngas temperatures for efficient heat recovery.

Various aspects of the invention described herein may be applied to any of the particular applications set forth below or for other types of gasification systems. The invention may be applied as a standalone system or method, or as part of an application, such as a gas production plant. It shall be understood that different aspects of the invention can be appreciated individually, collectively, or in combination with each other.

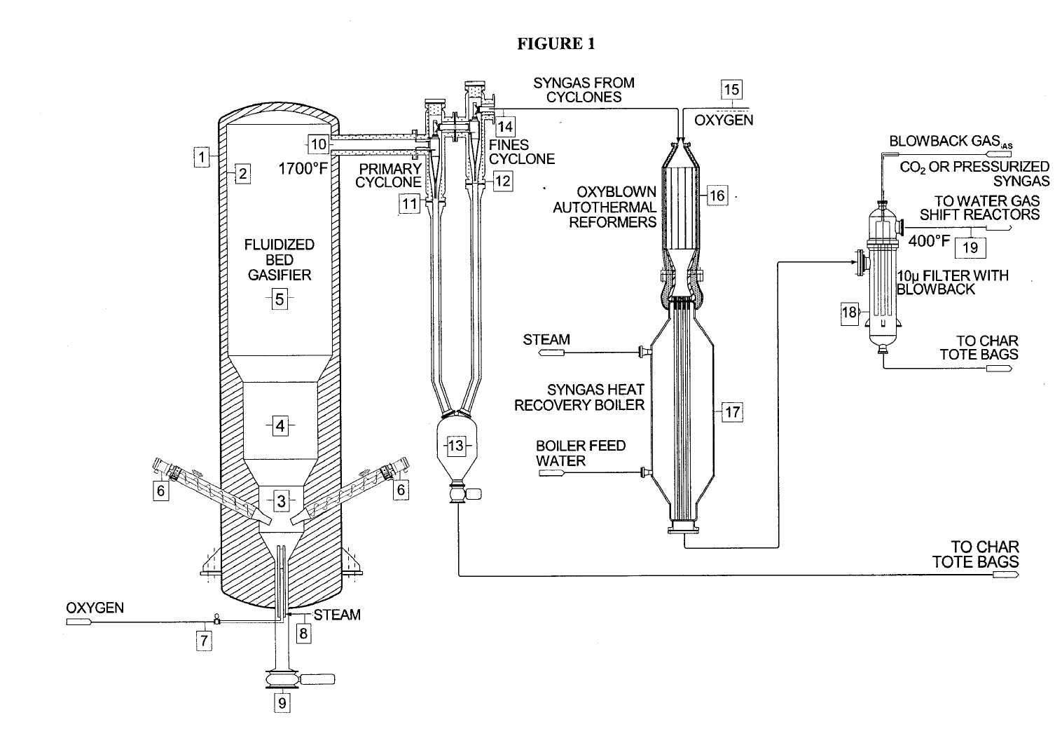

FIG. 1 shows a gasifier and gasification system in accordance with an embodiment of the invention. Various mechanical sections of the proposed multi-stage progressively expanding fluidized bed gasifier may be identified in FIG. 1 as follows: gasifier shell 1 (may include high strength carbon steel), refractory 2, reactive stage or section 3, fluidized bed stage or section 4, disengagement stage or section 5, biomass feed line 6 (the location and angle of entry of this feed line may be influenced by the physical properties of the biomass that is being gasified, oxygen supply line 7 (this line may also be used to supply natural gas (CH₄) for initial fire-up/start, and carbon dioxide (CO₂) on an as-needed basis), steam supply line and shroud 8, tramp material annulus and recovery section 9, exit line for syngas plus fines 10, primary cyclone separator 11, fines cyclone separator 12, section for storing and discharging biochar/ash products 13, syngas exit from gasifier and cyclones 14, oxygen injection into autothermal reformer 15, oxyblown autothermal reformer 16, syngas heat recovery boiler 17, polishing filter with blowback 18, and syngas product 19.

The gasifier may include a plurality of stages, where a subsequent stage may be in fluid communication with a previous stage. In some embodiments, the subsequent stage may have a greater cross-sectional area than the previous stage. Any number of stages may be provided. In some instances, two, three, four, five, or more stages may be provided. For example, one or more reaction stage, fluidized bed stage, and disengagement stage may be provided. A pressurized gasifier may be configured such that the chemical kinetics within the reaction zone, and the geometry of its multiple stages and inter-stage transitions may facilitate to reduce the formation of methane, volatiles and tars.

Gasifier

The gasifier may use a method and process for converting biomass into biosynthesis gas (biosyngas), a mixture of gases that may include hydrogen (H₂) and carbon oxides (CO & CO₂), wherein the levels of methane (CH₄), volatiles and tars may be reduced, minimized or eliminated in the composition of the end product.

The input streams fed into the gasifier may include field or custom dried biomass (5-25% intrinsic moisture content), and controlled amounts of oxygen (O₂), steam (H₂O) and carbon dioxide (CO₂) as required.

The chemistry of the desired reactions in the gasifier may be substantially enhanced by the oxygen inherent in biomass, and the gasifier design may take special advantage of this fact of nature.

The chemical composition of a typical biomass feedstock in terms of carbon (C), oxygen (O₂) and hydrogen (H₂) is cited below:

Carbon: appr. 49 wt % (46 mol %),

Oxygen: appr. 44 wt % (16 mol %),

Hydrogen: appr. 7 wt % (38 mol %)

Alternatively, other chemical compositions of biomass feedstock may be utilized. For example, the approximate weight percent or mol percent may vary (e.g., carbon: appr. 45-53 wt %, 42-50 mol %, oxygen: appr. 40-48 wt %, 14-18 mol %, hydrogen: appr. 4-10 wt %, 34-42 mol %).

A typical equation for the conversion of biomass into biosyngas is:

C₃₈H₅₂O₂₂.14.27H₂O+13.01O₂→27.57CO+26.40H₂+10.43CO₂+13.87H₂O

The gasification may be conducted in a pressurized environment (e.g., 15-300 psig), and may make use of a single fluidized bed reactor that may feature progressively expanding beds with enabling transition zones, whereby the unique 3-zone geometry of the gasifier, combined with several other novel chemical and mechanical design embodiments, may optimize the residence time within each zone, and facilitate the kinetics of the underlying chemical reactions to yield the desired gas product. The gasification may be conducted in a pressurized environment with any pressure value, e.g., pressure values ranging from 5-500 psig, 10-400 psig, 15-300 psig, 20-250 psig, or a pressure close to or on the order of magnitude of 15 psig, 20 psig, 30 psig, 50 psig, 75 psig, 100 psig, 125 psig, 150 psig, 175 psig, 200 psig, 225 psig, 250 psig, 275 psig, or 300 psig. Depending upon location, temperatures within the gasifier can range from 1,450° F. to 2,000° F. In alternate embodiments, the temperatures within the gasifier may vary and may have any value.

The biomass may be injected deep into the lowest section of the fluidized bed gasifier, thus ensuring that most of the methane, tars and other volatile components that are generated are converted into their various equilibrium components.

Summary of Process Operations

Biomass may be introduced through a feed line 6 into the reactive section of the gasifier 3. In a preferable implementation, the biomass may be continuously introduced. Alternatively, the biomass may be introduced in a batch process. A biomass feed may enter the feed line at any rate, e.g., 5-30 tons/hr.

As noted earlier, the configuration, location and angle of entry of the feed line 6 may vary depending upon the physical properties of the biomass feedstock. For example, the feed line may enter a reactive section of the gasifier through a wall of the reactive section. In some embodiments, the feed line may be directed downward from the wall of the reactive section to a central region of the reactive section. Alternatively, the feed line may be directed at a different angle, such as upward, or horizontally. The feed line may be angled downward or upward at any angle (e.g., at about 5 degrees, 10 degrees, 15 degrees, 25 degrees, 35 degrees, 45 degrees, 55 degrees, 65 degrees, 75 degrees, or 85 degrees downward).

Ignition and initial heat-up actions in the gasifier may be facilitated by the addition of natural gas (CH₄) fuel through an oxygen feed line 7. After ignition and start-up have been achieved, the oxygen feed line 7 can be used to provide a flow of oxygen and/or supplemental carbon dioxide into the gasifier. Oxygen supply may occur at any rate, e.g., 2-8 tons/hr. The oxygen feed line may have any position or orientation. For example, the oxygen feed line may be directed upward from the bottom of a reactive section, and may be oriented at approximately the center of the cross-section of the reactive section. In alternate embodiments, the oxygen feedline may have another orientation or position (e.g., from the wall or top of the reactive stage, and vertical, horizontal, or angled).

The feed line 6 may be provided at an elevation above an oxygen feed line 7. In some instances, the feed line may provide a feed by angling downward over where oxygen is coming out of oxygen feed line. A biomass feed may emerge from the feed line in close proximity to where the oxygen is emerging from the oxygen feed line, or may emerge at some distance.

A steam supply line 8 may supply steam to facilitate the desired chemical reactions. Note that in accordance with one embodiment of the invention, the oxygen feed line 7 can be encased in the steam supply line 8, thereby creating a steam shroud around the oxygen stream. The oxygen feed may be annularly encased within the steam supply line, and the oxygen jet point or jet points may be surrounded by a steam shroud that may contain and stabilize the oxygen flame. In some instances, the steam shroud may also provide for optimizing reaction stoichiometry. Alternatively, various other configurations of the lines may be used. Furthermore, in additional alternative embodiments of the invention, rather than steam or in addition to steam, another gaseous medium may be used.

The steam line 8 can itself be encased within a larger pipe 9 that may be connected to the gasifier. The larger pipe 9 may preferably be connected to the bottom of the gasifier. Tramp materials and unreactive components in the biomass may flow down the line 9 and be collected in a catch pot at the bottom of the gasifier. A valve arrangement under the pot may permit the discharge of its contents on a programmed or as-needed basis.

The gasifier 1 and 2 may be configured as a progressively expanding vessel comprising multiple sections or stages, wherein each of the sections can perform its own special and sequential function to create the desired end product. In some implementations, the progressively expanding vessel may comprise three sections 3, 4, 5 and each of the sections may perform its own special function. For instance, the three sections may be a reactive section 3, a fluidized bed section 4, and a disengagement section 5. In other implementations, other numbers of sections may be used.

In one example, the gasifier may have segmented stages for the reactive section 3, the fluidized bed section 4, and the disengagement section 5. There may be transition zones between the segmented stages. The transition zones may incorporate any configuration to accommodate the various cross-sectional areas of the stages. For example, the transition zones may have truncated conical sections or may be substantially funnel-like. The various sections and transition zones may incorporate any geometric shape. For instance, there may be a plurality of reactor zones with parallel or non-parallel side walls. The various sections and transition zones may also have various volumetric regions. For instance, the bottom regions may have smaller regions than the upper regions (i.e., expanding larger telescoping reactor interior volumes), although in other instances the various regions may have the same volume or any arrangement of volumes.

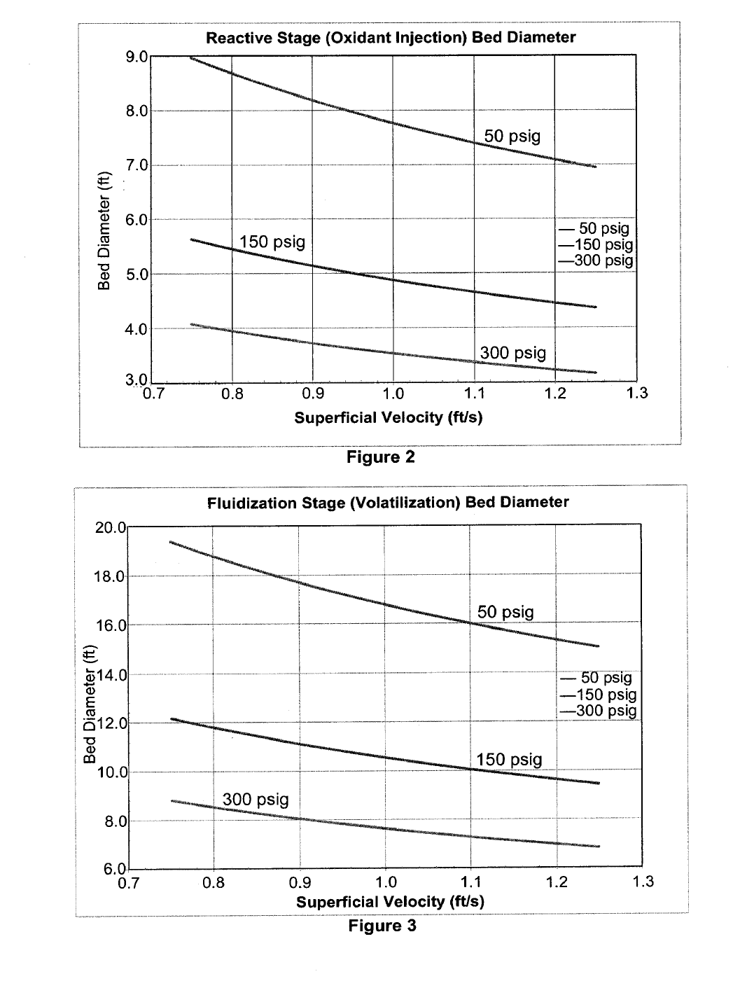

This gasifier may be designed to operate at an exit temperature of about 1,750° F. and pressures ranging from 15 psig thru 300 psig. The results of an analysis that looks at bed diameters as a function of superficial velocity for different pressure ranges is presented below. FIG. 2 shows a first chart that is pertinent to the reactive (oxidant injection) stage wherein the fluidizing gases are oxygen and steam. FIG. 3 shows a second chart that represents a condition where some of the oxidant has been depleted and the biomass feed (a highly reactive material) has been converted into gaseous products. This signifies a considerable increase in the total molecular flow of gases in this section—the fluidization (volatilization) stage.

Addition of sulfur into biomass feedstocks is a valuable protocol. The sulfur converts to H₂S during the gasification step. The presence of H₂S in the syngas stream mitigates metal dusting in the waste heat recovery boiler. Additionally, syngas produced from biomass gasification will typically contain H₂S ranging from levels of 50 ppm to 500 ppm. In most cases, the water gas shift catalysts that are tolerant to H₂S need a sulfur level between 500 to 700 ppm. Thus, it is a simple step to control the H₂S levels in the syngas going to the water gas shift reactor by addition of powdered sulfur into the biomass. It is also an inexpensive way of doing it compared to the conventional technique of injecting dimethyldisulfide (DMDS) into the syngas stream upstream of the water gas shift reactors.

In accordance with an embodiment of the invention, elemental sulfur may be added into a gasifier, preferably via a biomass feed injection point. The elemental sulfur may be converted into hydrogen sulfide in the gasifier. The hydrogen sulfide may mitigate the metal dusting problem in a downstream heat recovery boiler. The concentration of hydrogen sulfide in syngas can be managed by the addition of elemental sulfur into the biomass feed. The hydrogen sulfide level can be optimized to ensure high activity performance of the sulfur tolerant water gas shift catalyst. The hydrogen sulfide levels needed or used for good water gas shift operations may range from 300 ppm to 1,000 ppm.

The biomass feedstock may be augered or otherwise fed 6 into the reactive section 3. Oxygen can also be injected into the reactive section 3 by a feed line 7, and the reactive action of the oxygen may be “modulated and contained” by means of a steam blanket (line 8).

Ignition and start-up may be conducted by feeding and firing a small amount of natural gas plus oxygen and/or air. This may be continued until a point where the gasification reactions become self-sustaining.

The products from the reactive section 3 may expand and flow upwards into the fluidized bed section 4. The expansion may be modulated by a taper of a transition zone between these two sections. The fluidized bed section may have a greater cross sectional area than the reactive section.

The products leaving the reactive section can be subjected to intense mixing in the fluidized bed section 4. In accordance with one embodiment of the invention, a preferable residence time may be 15 to 150 seconds in the fluidized bed section. Other embodiments of the invention may provide other desired residence times, such as 10-15 seconds, 15-50 seconds, 50-100 seconds, or 100-1,000 seconds. As the reactants fill up this section, they may continue to expand and flow upwards into the disengagement section 5. Here again, the expansion may be modulated by a taper of the transition zone between the fluidized bed section 4 and the disengagement section 5. The disengagement section may have a greater cross sectional area than the fluidized bed section.

A certain amount of fluidized bed activity may continue to take place in the lower part of the disengagement section 5. The fluidized bed activity in the disengagement section may be characterized by a dense phase that may be 2-3 feet in depth. The free board height of the disengagement section may be sufficient to enable adequate separation of the particulate matter (biochar and ash) from the syngas product.

Partially reacted biomass that is carbonaceous in nature is referred to as biochar. Most of the biochar and inorganic ash that may be entrained in the upper section of the fluidized bed will flow out along with the syngas into the primary cyclone 11. In preferable implementations, the biochar and ash may gravity-flow into a storage vessel 13 equipped with a valve arrangement to discharge its contents on a programmed or as-needed basis. Alternate configurations and methods of removing the biochar and ash from the disengagement section to a storage vessel may be used.

The product gas, including some fines, may leave the primary cyclone 11 through an exit line. The fines can be separated in a cyclone 12 and flow into the storage vessel 13. The final product gas, minus captured fines, may leave the fines cyclone through a final product line 14, after which the gas may be subjected to conventional heat recovery and conditioning procedures.

The bubbling bed in the gasifier may service both the reactive and fluidizing stages. The particle size of the fluidizing bed media may be selected or optimized with respect to the gas flow rates and may also take the reactivities of the biomass into consideration.

In biomass gasification sometimes the presence of tar in the product gas is undesirable. The bubbling bed of material may be specifically designed to crack tar components. A significant amount of research has been conducted in terms of evaluating various bed additives for tar removal. Two materials that have exhibited good catalytic tar cracking capabilities are dolomite and olivine. Olivine, a mineral containing magnesium oxide, iron oxide and silica is advantageous in terms of its attrition resistance. Recently, it has also been determined that pretreatment of olivine tends to improve its catalytic activity. The pretreatment method includes heating olivine at 1650° F. in the presence of air for appr. 10 hours.

The gasifier may be additionally equipped with an internal cyclone connected to a dipleg where the location has to be heuristically determined. The designs of the oxygen injection nozzles/steam (CO₂) shrouds may be based upon various correlations. Bed heights offer the appropriate gas and solids residence times needed to attain the necessary conversion levels. The disengagement section may be designed with a generous height to minimize or reduce any spill over of the olivine fluidizing media/cracking catalyst.

This invention may demonstrate a proposed method that is 100% energy neutral, and does not require any external/additional energy resources to enable sustained operation. In some embodiments, the invention may demonstrate a proposed method that is substantially energy neutral, or very close to energy neutral. For instance, a pressurized biomass gasifier process may be essentially self-supporting in terms of its energy requirements, and except for the inherent energy content of its feedstock, may not require any other external supplies of energy.

Finally, this invention may offer a significant benefit in terms of carbon management and sequestration. The gasifier may be deliberately operated in a substoichiometeric mode that leaves 5-10% of the biomass feedstock in the form of a highly valuable biochar and inorganic mineral ash mixture, which when recovered, can be sold and recycled as a premium fertilizer and soil enhancement agent.

A typical output of gas produced at an operating temperature of 1,750° F. (gasifier) and 1,500-1,550° F. (autothermal reformer) is H₂˜vol (mol) 34%; CO˜vol (mol) 31%; CO₂˜vol (mol) 15%; H₂O˜vol (mol) 18%; CH₄˜vol (mol) 2%. However, other gas outputs may be provided under various operating conditions.

Tar Cracking

One of the major concerns in biomass gasification is the presence of tar, volatiles and methane in the product gas. In some applications, tar may be undesirable because it can create problems when it condenses, forms tar aerosols and polymerizes to form more complex structures.

Tar is a complex mixture of condensable hydrocarbons that includes single ring to multiple ring aromatic compounds along with other oxygen containing hydrocarbons and complex polycyclic aromatic hydrocarbons. Tar is normally considered as a single lump of hydrocarbons. Significant efforts have been directed towards identifying all the constituent components of tar and the inter-connection between them. Several researchers have tried to put tars in different classes and are studying the relationship between these compounds.

Milne et al. at NREL classified tars into four different groups depending on reaction regimes. These four groups are: ‘primary products’ which are characterized by cellulose-derived, hemicellulose-derived and lignin-derived products; ‘secondary products’ which are characterized by phenolics and olefins; ‘alkyl tertiary products’ which are mainly methyl derivatives of aromatic compounds; ‘condensed tertiary products’ which are PAHs without substituent groups. Primary products are destroyed before the tertiary products appear.

In Europe, the tar classification system is: GC-undetectable tars (class 1: these are very heavy tars, cannot be detected by GC); heterocyclic compounds (class 2: tars containing heteroatoms; highly water soluble compounds); aromatic compounds (class 3: light hydrocarbons with single ring, do not pose a problem regarding condensability and solubility); light polyaromatic compounds (class 4: two and three ring compounds, condense at low temperature even at very low concentration); heavy polyaromatic compounds (class 5: larger than three rings, these components condense at high temperatures at low concentrations).

Tar decomposition primarily occurs due to cracking, steam and dry reforming reactions as shown below, due to destabilization of the hydrocarbon, which then leads to fragmentation of the molecule by breaking of C—C and/or C—H bonds. These fragments undergo different reactions to form gaseous products.
Cracking pCₙHₓ→qCₘH_{y}+rH₂
Steam reforming CₙHₓ+nH₂O→(n+x/2)H₂+nCO
Dry reforming CₙHₓ+nCO₂ (x/2)H₂+2nCO
Carbon formation CₙHₓ→nC+x/2H₂

CₙHₓ represents tar and CₘH_{y} represents hydrocarbons with carbon numbers less than CₙHₓ.

Of all biomass tars, naphthalene, is one of the most stable in the temperature range of 1,350° F. to 1,650° F., and the formation of aromatic tar species without substituent groups, e.g. benzene, naphthalene, phenanthrene etc. is favored. Hydrocarbons without such a substituent group attached to the benzenoid ring structure are relatively stable. Decomposition of these hydrocarbons occurs at temperatures above 1,500° F., and naphthalene is observed to be the most stable. Naphthalene contributes a major part of the total tar product, even after severe catalytic treatment with dolomite and olivine at a very high temperature of 1,650° F.

Tar removal technologies can be broadly divided into two approaches: cracking and treatments inside the gasifier (primary methods), and hot gas cleaning downstream of the gasifier (secondary methods).

Olivine Sand

Olivine is a naturally occurring material containing magnesium, iron oxide and silica. It offers much better resistance over dolomite. Olivine has excellent performance in terms of tar cracking and its activity is comparable to calcined dolomite: more than 90% reduction in average tar content.

Olivine is a nonporous material with an orthorhombic structure and an extremely low surface area. Its hardness makes it attractive as an in-bed additive for biomass gasifiers.

TABLE 1
COMPOSITION OF OLIVINE (AS INDICATED BY SUPPLIER)

| Composition | Concentration (wt. %) |
|---|---|
| MgO | 49 |
| SiO₂ | 41 |
| Fe₂O₃ | 7 |
| Al₂O₃ | 0.5 |
| Cr₂O₃ | 0.3 |
| NiO | 0.3 |

In olivine, iron is usually present as FeO; and its oxidation state can be changed to Fe₂O₃ by preheating with air. It is generally recognized that iron, as Fe₂O₃, is responsible for the tar cracking reactions.

Increasing the pretreatment time with air at high temperatures improves the activation properties of olivine. For example, the effect of pretreatment time of olivine up to 10 hours, showed significant improvement in the catalytic activity of olivine. Naphthalene conversion of more than 80% is observed, a significant improvement over untreated olivine.

Pretreatment of olivine with air at 1,650° F. improves its catalytic activity with a significant increase in naphthalene conversion.

A small amount of M_{g}O must be added to the fresh olivine to avoid the formation of glass-like bed agglomerations that would result from the biomass potassium interacting with the silicate compounds. The M_{g}O titrates the potassium in the feed ash. Without M_{g}O addition, the potassium will form glass, K₂SiO₄, with the silica in the system. K₂SiO₄ has a low melting point (˜2,370° F.) ternary eutectic with the silica, thus sequestering it. Potassium carry-over in the gasifier/combustor cyclones is also significantly reduced. The ash content of the feed may be assumed to contain 0.2 wt % potassium. The M_{g}O flow rate is set at two times the molar flow rate of potassium.

Gasifier Shell and Refractory

In one implementation, the gasifier shell 1 may be made of high strength carbon steel, wherein the thickness of this steel depends upon the exact operating pressure. Various materials with desirable thermal and structural properties may also be used to form the shell.

In the reactive section 3 at the bottom of the gasifier, the carbon steel may be lined with a castable refractory 2 that can handle a working temperature of up to 2,000° F., with the refractory thickness calculated to provide an external temperature of about 300° F., thereby allowing a controlled amount of heat to flow out radially. The reactive section with its castable refractory may be connected to the rest of the gasifier with flanges so that it can be occasionally pulled apart for maintenance and upkeep.

The two upper sections, namely the fluidized bed 4 and the disengager 5 may be lined with a spray-on refractory 2 that may be easy to set up, and may not be subject to the hard duty required by the reactive section.

An exit nozzle for the biochar/ash overflow line 10, and a nozzle for the product gas exit line 11, may also be protected with castable refractory.

Deep Injection of Biomass Feedstock may Reduce Wall Effects

One aspect of the invention may provide a gasifier design that includes an embodiment that has to do with a manner by which a biomass feedstock may be introduced into the reactive stage/section 3. Unlike most other gasifiers, the solid feed may not be dumped through “a hole in the wall.” Rather, biomass may be deliberately and carefully injected 1) as close to the bottom of the reactive stage/section as possible, and 2) such that the feed point is geometrically centered. The feed may be received by the reactive stage at a centralized region that may be substantially near the center of the cross-section of the reactive stage.

In some instances, the feed may be provided through a biomass feed line that may be roughly cylindrical in shape. The feed line may have a tubular component and/or a substantially conical component. The feed line may extend from the side of a reactive section toward a central and lower region of the reactive section.

In a high temperature environment, the deep injection strategy may be more complicated than a simple “dump” approach, but may greatly reduce the adverse wall effects that are commonly experienced with many other biomass gasifiers—both atmospheric and pressurized.

From a chemistry perspective, the deliberate and deep/centralized injection of the biomass into the reactive hot section 3, may also increase the decomposition of several pyrolysis products into the desired primary and secondary components.

The deep injection may occur at various angles of entry from various locations, and may result in the feed being directed to different locations, possibly depending on the physical properties of the biomass feedstock. The feeding mechanism 6 of the biomass into the gasifier may be separate from an oxygen feed line 7 or a steam supply line 8. In one example, the biomass feeding mechanism 6 may come through the wall of the reactive section 3 while the oxygen feed line 7 and/or the steam supply line 8 may be directed upwards from a bottom of the reactive section 3. The biomass feeding mechanism 6 may be angled such that it is not an upward free jet, and is therefore not limited by free jet expansion angles. In some embodiments, the biomass feeding mechanism may be angled downwards, such that biomass may fall into a desired location. In other embodiments, the biomass feeding mechanism may be configured so that it may be angled upwards or perpendicularly.

The products from the reactive section 3 may expand and flow upwards into a fluidized bed section 4 and disengagement section 5. These expansions may be modulated by a taper of these transition zones. In some examples, the taper of these transition zones may be about 30 to 40 degrees. In other examples, the taper of these transition zones may have other angles, such as 20 to 50 degrees, or 15 to 60 degrees.

In some systems, in the absence of a directed outward discharge, a free jet may expand outward at an angle of approximately 7½° to vertical. See e.g., U.S. Pat. No. 4,391,611; Vaccaro, S., Analysis of the variables controlling gas jet expansion angles influidized beds, Powder Technology Vol. 92 No. 3 (1997), p. 213-222, which are hereby incorporated by reference in their entirety. For instance, a combustion jet in a fluidized system may also tend to expand at approximately 7½°, 5°, or 2.35° to vertical.

In such systems, nozzle diameter (d₀) to bed solids diameter (dₚ) ratio may be less than 7.5, such that the bed solids diameter may be greater than 0.133 inch (6 mesh). The two-phase Froude number may be expressed as:

$${F}_{rtp} = {( \frac{{U}_{o}^{2}}{{gd}_{o}} \frac{{ρ}_{g}}{{ρ}_{p} - {ρ}_{g}} )}^{1 / 2}$$

where

Uo=gas velocity at nozzle

g=gravitational constant

ρ_{g}=gas density

ρₚ=bed solid density

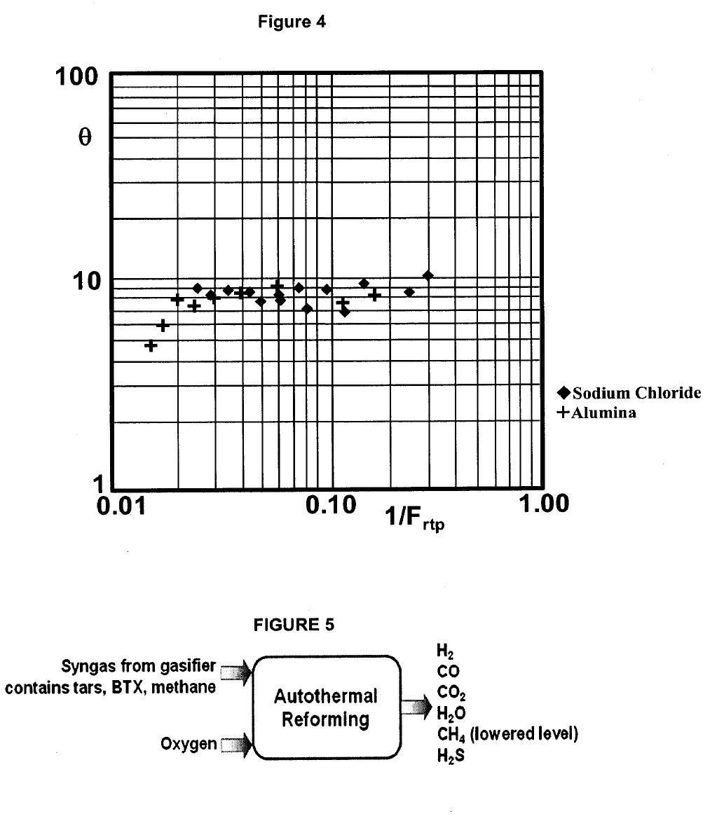

The inverse of the two-phase Froude number for such systems is in the range of greater than 0.02 and the angle of free jet expansion (θ) may be 4.7° to 11°, as shown in FIG. 4. Table 2 designated below, may provide a key and specifications for FIG. 4.

TABLE 2
SOLIDS PROPERTIES, PRESSURE, TEMPERATURE AND NOZZLE DIAMETERS
USED IN THE EXPERIMENTS FOR MEASUREMENTS OF θ

| Bed material | Symbol | dₚ (×10⁻³ m) | ρₚ (kg/m³) | P (bar) | T (° C.) | d₀ (×10⁻³ m) |
|---|---|---|---|---|---|---|
| Sodium chloride | ♦ | 0.418 | 2180 | 1 | 20 | 1, 2, 3 |
| Alumina | + | 0.107 | 2000 | 1 | 20 | 0, 5, 1, 2 |
| Char | ⋄ | 0.610 | 2075 | 1, 10, 15, 20 | 20, 650, 800 | 5 |
| Limestone | × | 0.643 | 2640 | 1, 10, 15, 20 | 20, 650, 800 | 5 |
| Limestone | * | 0.875 | 2600 | 1 | 20 | 7.1^{a} |
| Bronze | ▪ | 0.385 | 8500 | 1 | 20 | 7.1^{a} |
| Alumina | | 0.255 | 1550 | 1 | 20 | 7.1^{a} |
| Limestone | [symbol] | 0.875 | 2600 | 1 | 20 | 17.5^{a} |
| Glass ballotini | ◯ | 0.875 | 2600 | 1 | 20 | 17.5^{a} |
| Lead shots | ⊕ | 1.8 | 11300 | 1 | 20 | 17.5^{a} |
| Plastic beads | □ | 2.9 | 1200 | 1 | 20 | 17.5^{a} |
| Glass beads | Δ | 2.9 | 3000 | 1 | 20 | 17.5^{a} |
| Polycarbonate cylinders | [symbol] | 2.9 | 1117 | 1 | 20 | 17.5^{a} |

^{a}d₀ is the hydraulic diameter

In one aspect of the invention, as discussed previously, the biomass may be introduced through a feed line 6 into a reactive section of the gasifier 3, oxidant through oxygen feed line 7, and steam through steam supply line 8. The gasifier shell 1 and internal refractory 2 may be configured as a progressively expanding vessel comprising multiple sections, such as the reactive section 3, the fluidized bed section 4, and a disengagement section 5. The biomass may be introduced through the feed 6 such that the feed is not an upward free jet as described previously, and therefore may not be limited by free jet expansion angles. The biomass may expand at any desired angle, which may be affected by the placement of the biomass feed inlet 6.

In some embodiments of the invention, the free jet expansion angles may range from 4.7 to 11 degrees. In other embodiments, the free jet expansion angles may have other values. In some embodiments of the invention, the steam and/or oxygen may have a directed discharge, such that expansion angles may have any value that may fall within a desired range. Such desired range may have any value, for example, from 2 to 20 degrees, 5 to 15 degrees, 7 to 12 degrees.

Steam Shroud may Stabilize/Enhance Gasifier Operation

Past experience with oxygen-blown gasifiers has shown that, unless properly managed, the oxygen flame can create some serious problems. This is more than ever true when the flame is surrounded by biomass that is continuously and simultaneously being consumed and replenished. If the flame is not adequately constrained, it may almost appear to have a temperamental mind of its own that can cause the flame front to change its angle and “dance.”

In accordance with another aspect of the invention, the gasifier may include a design feature that may enable containment and management of the operation of the oxygen flame. In some implementations, the oxygen lance 7 may be protectively shrouded by the steam line 8. For example, the steam line 8 may form an annulus around the oxygen lance 7. Furthermore, the tip of the steam shroud can extend beyond the oxygen exit jet, thereby creating a blanket of steam around the flame that may provide a stabilizing effect, especially in the lower and more sensitive regions of the flame.

In some embodiments of the invention, any gaseous medium that is relatively lean in oxygen content may be used, rather than steam. Thus, the gaseous medium may form an oxygen-lean region around the flame, which may prevent the flame from dancing very much beyond the oxygen-lean region and may stabilize the flame.

In some implementations of the invention, the oxygen lance 7 and steam line 8 may be configured to provide a flame at or near the bottom of the centralized region of a reactive section. In other embodiments of the invention, the flame may be provided at other regions of the reactive section.

Notwithstanding the modulating action of the steam shroud, the gasifier design may call for an internal diameter in the hot section of the gasifier 3 in accordance with some embodiments of the invention. In other gasifiers, it has been found that if the flame changes angle and manages to impinge upon the refractory wall, it tends to hold its position, which can then cause a catastrophic loss of insulation. A sufficiently large internal diameter in the reactive stage/section 3 may provide a double measure of protection. The internal diameter may be varied depending on the various conditions.

If Needed, Carbon Dioxide Can be Added

Using a typical biomass as feedstock, the multi-stage gasifier may produce a syngas with a hydrogen (H₂) to carbon monoxide (CO) molar ratio that is close to one. While this particular syngas composition may be highly suited for downstream conversion into dimethylether (DME), other end products may require a different H₂/CO molar ratio.

For many applications, the H₂/CO molar ratio may preferably be greater than one, in which case the hydrogen content of the gas can be increased by means of a conventional water gas shift reaction.

However, the recent growth in the field of cellulosic ethanol via the fermentation route has created a growing demand for syngas with a H₂/CO molar ratio of less than one. The multi-stage gasifier can readily meet this requirement by an injection of carbon dioxide (CO₂) into the oxygen supply line 7. The amount of CO₂ that is fed into the reactive section can be modulated to achieve a desired H₂/CO molar ratio that is less than one.

Invention can take Advantage of the Oxygen Inherent in Biomass

The chemistry of the desired reactions in the multi-stage gasifier can be substantially enhanced by the oxygen inherent in biomass, and the gasifier design may take special advantage of this fact of nature.

The chemical composition of a typical biomass feedstock in terms of carbon (C), oxygen (O₂) and hydrogen (H₂) is cited below:

| | | |
|---|---|---|
| Carbon: | appr. 49 wt % | appr. 46 mol % |
| Oxygen: | appr. 44 wt % | appr.16 mol % |
| Hydrogen: | appr. 7 wt % | appr. 38 mol % |

As previously discussed, a biomass feedstock may have varying compositions. For example, the biomass feedstock may have weight percentages or mol percentages that may vary from the example provided.

In contrast, please note that coal contains very small amounts of oxygen, petroleum products and natural gas do not contain any oxygen.

Wide Variety of Biomass Feedstocks

The types of biomass that can be processed in the proposed gasifier to yield syngas may include, but may not be limited to, the following materials:
Virgin wood, hogwood, woodchips and sawdust.
Specially cultivated fast growing trees.
Agricultural crop residues—corn stover, corn cobs, wheat straw, rice straw, bagasse, etc.
Switchgrass, kudzu and water hyacinth.
Agricultural industry processing residues—ethanol plant solid byproducts (dried distiller's grains and solubles—DDGS), cereal husks, oat hulls, legume skins, etc.

To simplify handling, transportation and injection into our gasifier, these materials may be pre-classified, cubed or pelletized on an as-needed basis.

Reducing Methane, Volatiles and Tars

One aspect of the invention may provide a design to reduce the amounts of methane, volatiles and tars in the end product, i.e., the synthesis gas that leaves the system via a product line 14.

The amount of methane, volatiles and tars in the product may be reduced by incorporating the following two design features:

1. Using a relatively low operating pressure range of about 15-100 psig. Under these conditions, the underlying thermodynamics tend to discourage the formation of methane.

2. Providing a geometry of the gasifier that may be specially configured to increase the total residence time of the biomass within the apparatus. Forcing an increase in the hold-up duration can encourage the conversion of the tars and volatiles into their degradative components.

For certain types of biomass, such as corn stover, the bed density may be manipulated in order to increase the solid-gas contact time. This manipulation can be readily achieved by the addition of an inert material such as sand.

In some embodiments, methane formation may be reduced based on oxygen feed, discussed further herein. In some embodiments, the addition of various amounts of oxygen may reduce the methane mole fraction by a 60% or greater, 70% or greater, 80% or greater, 83% or greater, 85% or greater, 87% or greater, 90% or greater, 95% or greater, 97% or greater, 99% or greater reduction, or any other percentage reduction. Alternative factors may result in methane formation reduction in any amount, such as those described.

Controlled Production of Biochar

In addition to making a primary product, i.e., syngas, the multi-stage gasifier may also be designed to convert a certain amount of the available carbon into biochar. This biochar, mixed with inorganic ash that may also be recovered, may be a byproduct that can be sold to generate additional revenues.

The biochar and ash mixture—also known as “agri-char”—is an excellent organic fertilizer and soil conditioning agent.

In a natural carbon cycle, plant matter decomposes rapidly after the plant dies, which in turn emits CO₂ into the atmosphere. To the extent that the provided gasifier can convert some of the biomass into biochar, it may be able to sequester the carbon in a much more stable form. The carbon captured in the biochar may go back into the soil—this virtually permanent storage means that the gasifier may be a true carbon-negative engine.

Most of the biochar, plus some of the ash, can flow through the overflow line 10 into the storage section 13. The balance of the biochar and ash can be separated in the cyclone 12, following which this material may also be diverted into the storage vessel 13, or alternatively into another location. The biochar and ash mixture can be discharged on a programmed or as-needed basis.

The fact that the gasifier design may not require the recycling of fines may greatly simplify the operation of the gasifier. The gasifier may not require any internal cyclonic collection devices or complex dip legs. Some embodiments may include only one temperature control loop; however, one or two more loops may be added in some implementations to optimize the production of biochar.

Biochar Ash Recovery in Cyclones

Biosyngas leaving the gasifier may typically contain ash and biochar solids. The separation of these solids from biosyngas is a unique challenge because in addition to high temperatures, there is a need to maintain high flow rates and minimize or reduce pressure drops. An effective way to conduct this operation is by using refractory lined cyclones.

Two cyclones may be incorporated in series. The first cyclone may be designed to handle and separate out the larger particles and the second cyclone may address the removal of small particles.

The syngas leaving the second cyclone, regardless of the cyclone removal efficiency, may still contain submicron sized particles and exhibit a “smoky” characteristic that can only be removed by absolute filtration devices.

In some alternate embodiments of the invention, additional cyclones may be incorporated to provide the desired amount of particle removal. For example, two, three, four, or more cyclones may be incorporated in series.

Oxidative Autothermal Reformer (CH₄ & Tar Reforming)

Even though a majority of the solids are removed in the prior section, there might still be the need to selectively remove tars and benzene/toluene/xylene components present in the syngas leaving the oxidative gasifier.

In accordance with aspect of the invention, a process may be provided for the simultaneous removal of tars and benzene/toluene/xylene (BTX) components, and for decreasing methane concentration while optimizing energy efficiency. The method may use an oxyblown autothermal catalytic reformer for this purpose. The oxyblown catalytic autothermal reactor may be downstream of the gasifier. The reactor may reform residual tars, volatiles, and methane.

Autothermal reforming combines the heat effects of partial oxidation and steam reforming reactions by feeding the humid syngas and oxygen into the reformer. This process may be carried out in the presence of a catalyst, which controls the reaction pathways and thereby determines the relative extents of the oxidation and steam reforming reactions. The presence of steam, oxygen and the use of an appropriate catalyst may enable lower temperature operation and greater product selectivity to favor the formation of H₂ and CO, while inhibiting the formation of coke (solid carbon). A representation schematic is shown below in FIG. 5.

The initial catalytic oxidation reaction may result in the generation of heat and high temperatures. The heat of the oxidation reaction can be used for steam reforming the remaining fuel by reacting it with an appropriate amount of steam.

The general autothermal reforming reaction is noted below.

CₙHₘOₚ+χ(O₂)+(2n−2χ−p)H₂O=nCO₂+(2n−2χ−p+m/2)H₂

Lower temperature processing (compared to steam reforming and partial oxidation) favors the water gas shift reaction, which results in a higher selectivity for carbon dioxide and hydrogen.

CO+H₂O═CO₂+H₂

The catalytic partial oxidation reaction is exothermic in nature and the heat generated may be used to facilitate the steam reforming reaction that is endothermic. With the catalytic partial oxidation layer in intimate contact with the steam reforming catalyst layer, the process heat can be more effectively managed in an adiabatic mode (the autothermal reactor). In a preferable configuration, the thickness of the partial oxidation catalyst layer may be maximum or increased at the point of initial contact with the preheated inlet stream, and may be gradually reduced in thickness along the length of the monolithic substrate. Concurrently, the thickness of the steam reforming catalyst layer may be minimum or reduced at the point of initial contact with the preheated inlet stream, and may be gradually increased along the axial length of the monolithic substrate.

Monolith substrates are often referred to as honeycombs and a preferable form is made from a substantially inert rigid refractory material that is capable of maintaining its shape and mechanical properties at temperatures up to 2,050° F. Preferable materials may include special ceramics such as cordierite, a porous composition of alumina-magnesia-silica oxides. In these cordierite honeycomb monoliths, the gas flow passages are typically sized to provide 20 to 300 gas flow channels per square inch of face area to minimize or reduce pressure drop and still maintain an appropriate amount of catalytic surface area.

As noted earlier, the biosyngas leaving the cyclones may still contain small submicron size particles. A further attribute of a honeycomb monolith substrate is the fact that smoky particles can flow through without impinging and accumulating on the catalyst. There is enough linear velocity within the channels to eliminate this problem.

A series of simulations were conducted in order to demonstrate the effect of adding oxygen into the autothermal reformer, and the effluent temperature, gas composition and total quantity of hydrogen and carbon monoxide produced were studied. For each case, the gas composition shown below was assumed to enter the autothermal reformer at a temperature of 1750° F., a pressure of 150 psig and a molar flow rate of 2279 lb-mol/hr.

TABLE 3

| COMPONENT | MOLE FRACTION |
|---|---|
| CH₄ | 0.0604 |
| CO₂ | 0.1610 |
| CO | 0.2921 |
| H₂O | 0.2168 |
| H₂ | 0.2667 |
| N₂ | 0.0022 |
| H₂S | 0.0008 |

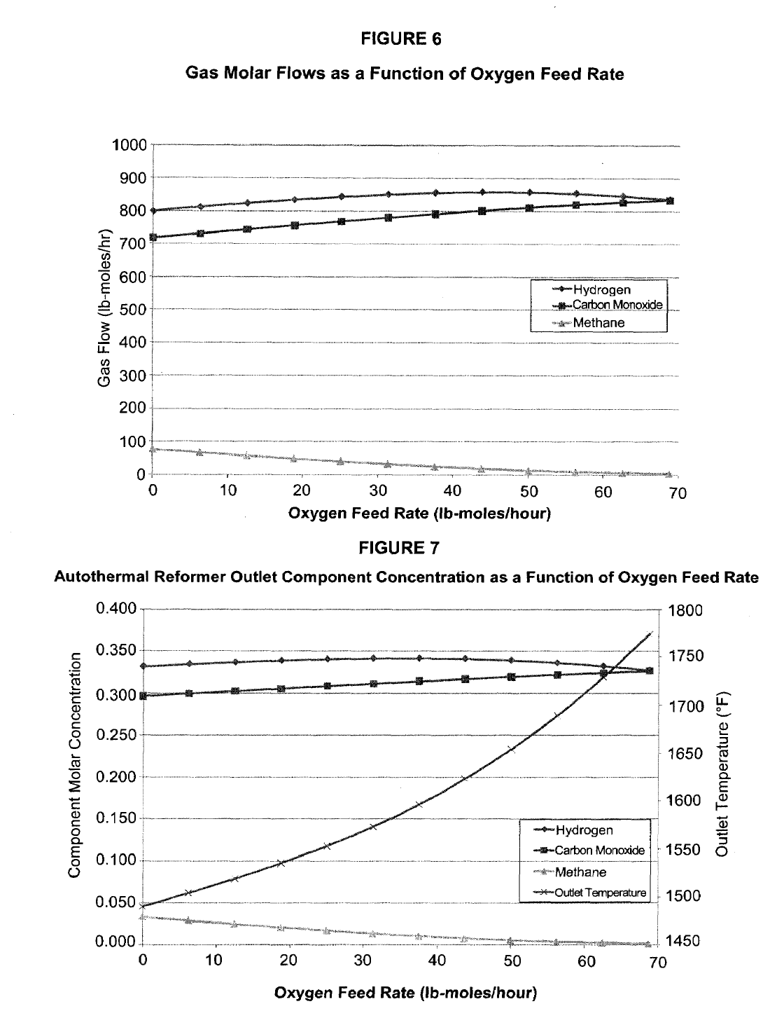

FIG. 6 shows the effect that increasing oxygen feed may have on the concentration of H₂, CO and CH₄ in the effluent gas and upon the effluent gas temperature. In the case of zero oxygen, the methane composition (mole fraction) is reduced from 0.060 to 0.033, or about a 45% reduction, and the effluent temperature is 1510° F. In comparison, addition of 401b mol/hr of oxygen, reduces the methane (mole fraction) from 0.060 to about 0.009, an 85% reduction, and an outlet temperature of about 1630° F. In alternate embodiments, the addition of various amounts of oxygen may reduce the methane mole fraction by a 60% or greater, 70% or greater, 80% or greater, 83% or greater, 87% or greater, 90% or greater, 95% or greater, 97% or greater, 99% or greater reduction, or any other percentage reduction.

FIG. 7 shows the effect that increasing oxygen feed may have on the total moles of H₂, CO and CH₄ in the system. The moles of H₂ and CO combined may increase until their total reaches a peak at an oxygen addition rate of about 60 lb mol/hr.

Waste Heat Recovery

The effluent gases leaving the oxyblown autothermal reformer have a temperature of 1500-1700° F., so it makes eminent sense to recover this heat by making use of a waste heat recovery boiler. A preferable design for this application is a fire tube boiler in which the hot gases go through tubes surrounded by a water vessel. The equipment may be sized to reduce exit gas temperatures into the 400-600° F. range.

The syngas leaving the gasifier can create problems due to metal dusting in the waste heat boiler. Metal dusting involves the disintegration of metals and alloys into small particles of metals, metal carbides, metal oxides and carbon. It is believed that the transfer of carbon from the gas phase to the metal or alloys plays a key part in metal dusting. Carbon monoxide is the predominant cause of metal dusting, but hydrocarbons such as methane can also play a role. Metal dusting usually occurs at temperatures above 600° F.

It has now been recognized that the presence of H₂S in the syngas entering the waste heat boiler does minimize or reduce the issue of metal dusting. It is convenient to have H₂S levels in the range of 200 to 1,000 ppm.

In order to eliminate any problems associated with metal dusting, modem waste heat boilers may be lined with castable refractory in the flow fields. This ensures that the hot syngas does not come into contact with the connecting flanges, pipes and boiler tube sheets. The boiler tube sheets may be protected with a facing of high purity bubble alumina. Ceramic or high alloy ferrules are inserted into the metal boiler tubes to prevent the syngas from contacting the boiler tube metal. These ferrules extend up to a point at which the temperature drops below 600° F. following which direct contact can be made with metal.

Final Solids in Biosyngas Separation

The gases leaving the waste heat boiler may flow into a final solids removal section in which the submicron sized smoky particles are filtered out. Inline filtration using metal felt fiber may be an effective process for this application.

After some time on stream, the differential pressure increases as the solids may be captured on the surface of the filter element resulting in the gradual formation of a filter cake. This stable surface cake can then become a defacto filter media. A CO₂ blowback may be used to replenish the filter at predetermined differential pressures.

The solid metal filter elements have porosities between 70 to 85%, providing high efficiency particle capture while maximizing or increasing flowrates and minimizing or reducing pressure drops. The system may be equipped with a venturi pulse blowback with a nozzle directed into each venturi. A manifold may enable the blowback to take place in a pre-programmed sequential fashion. A fast acting valve creates a shockwave through the piping and nozzles, resulting in disengagement of the filter cake from the filter element, sending the cake into the bottom of the conical solids collection tank.

The blowback CO₂ pressure could be at least 70 to 80 psi above the system operating pressure, with a pulse duration between 0.25 to 0.5 seconds. Blowback in the process may use carbon dioxide (CO₂) obtained from a downstream point. This may ensure that no unnecessary inert such as nitrogen is introduced into the process biosyngas.

Product Gas

Examples of syngas that can be produced at operating temperatures of 1,750° F. (gasifier) and 1,500-1,550° F. (autothermal reformer) are:

TABLE 4

| | 10 wt % moisture | |
|---|---|---|
| COMPONENT | corn cobs, mol % | 23 wt % moisture corn cobs, mol % |
| H₂ | 34 | 33 |
| CO | 31 | 29 |
| CO₂ | 15 | 17 |
| H₂O | 18 | 19 |
| CH₄ | 2 | 2 |

### Wide Range of Applications

The syngas generated by the proposed method may have a H₂/CO molar ratio that is inherently close to 1. Some significant applications of this biomass derived gas product are cited below, along with the approximate H₂/CO molar ratio that may be preferable in each instance:
Dimethylether (DME), H₂/CO=1, no need for ratio adjustment.
Fischer Tropsch mixed alcohols, H₂/CO=1.25, ratio may be adjusted by water gas shift (WGS).
Fischer Tropsch diesel, H₂/CO>2, WGS may be implemented.
Methanol, H₂/CO=2.25, WGS may be implemented.
Hydrogen for fuel cells, H₂/CO>50, WGS may be implemented.
Ammonia, H₂/CO>50, WGS may be implemented.
Ethanol via catalysis, H₂/CO=1.25, WGS may be implemented.
Ethanol via fermentation of syngas, H₂/CO<1, controlled addition/injection of CO₂ into the biomass gasifier.

Although examples of H₂/CO molar ratios are provided, other ratios may be used for the applications described. For example, H₂/CO molar ratios may be within the range of 0.75 and 2.5. The gas mixture may be an appropriate composition for downstream DME, ethanol, butanol, and other miscellaneous Fischer-Tropsch products.

The syngas generated by the proposed method or system may be used to make an ammonia product, as discussed. The ammonia product may meet all accepted standards for classification as an organic fertilizer.

Additionally, a gasifier system may also produce a biochar product. In some instances, the gasifier system may produce a biochar (aka “agrichar”), which may be used to produce a soil conditioning agent, that may be a mixture of the biochar and inorganic ash residues (aka “bioash”). In some implementations, it may be desirable for the gasifier system to provide an increased co-production of biochar. The biomass gasifier may facilitate the long term sequestration of carbon in soil.

The gasifier system may also include an air separation unit, which may produce nitrogen as a byproduct. The nitrogen produced as a byproduct from the air separation unit may be combined with hydrogen produced from the biomass gasification system. Such combination may be used for the manufacturing of anhydrous ammonia.

The air separation unit may also provide oxygen into an oxyblown gasifier and into an oxyblown catalytic autothermal reactor. In some instances, the air separation unit may provide oxygen to the gasifier and reactor simultaneously.

Case Study—Gasifier for Manufacturing Ammonia from Biomass

In order to explain the geometry of the reactor, it is useful to consider a simple example. Corn cobs at 10 wt % and 23 wt % moisture may be fed into the gasifier. The feed rate may be about 384 and 466 tons/day on an “as-is” basis and 346 and 359 tons/day on a dry basis. Stoichiometric calculations show that this biomass will need about 105 and 120 tons/day of oxygen and about 271 and 197 tons/day of steam, respectively.

Underlying Chemical Equation

The gasification of biomass to generate a syngas with a H₂/CO molar ratio appr.=1 may be represented by the following simplified chemical equation:

C₃₈H₅₂O₂₂.14.27H₂O+13.01O₂→27.57CO+26.40H₂+10.43CO₂+13.87H₂O

### 1. Example

### Ammonia from Corn Cobs (10 wt % Moisture)

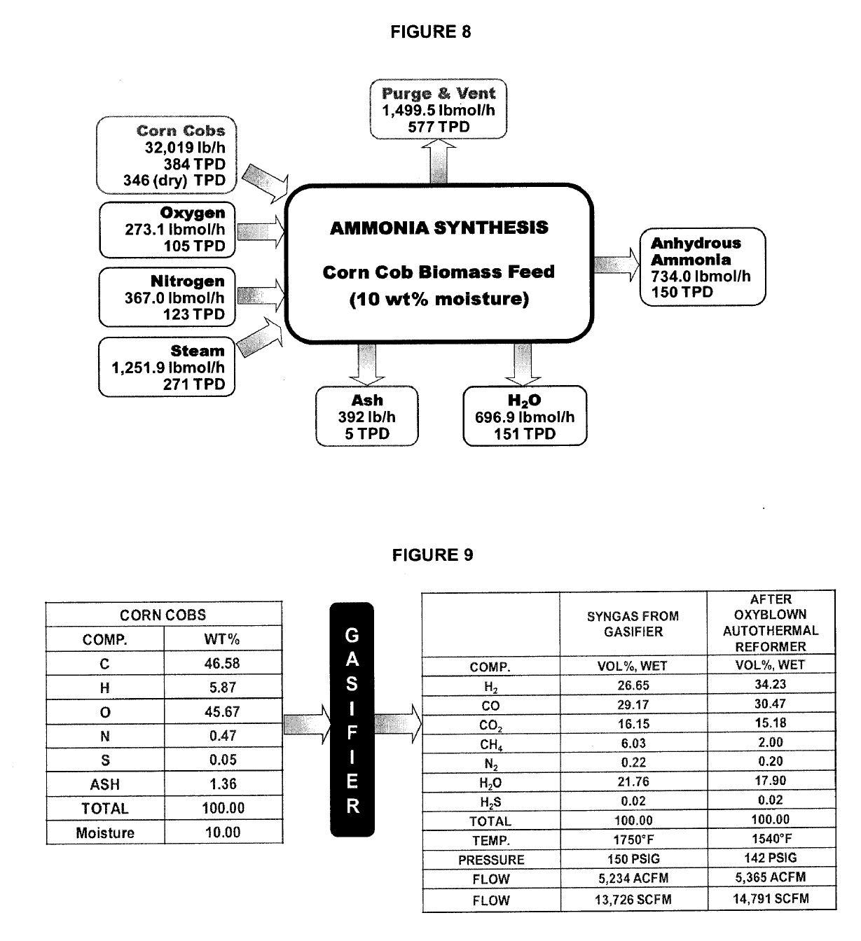

FIG. 8 shows an example of ammonia synthesis from a corn cob biomass feed with 10 wt % moisture. For example, corn cobs, oxygen, nitrogen, and steam may undergo ammonia synthesis and yield anhydrous ammonia, ash, water, and other items that may be purged and vented.

FIG. 9 shows an input and an output from a gasifier from a corn cob biomass feed with 10 wt % moisture. The make-up of the inputs to the gasifier may include carbon, hydrogen, oxygen, nitrogen, sulfur, and ash. The input may have a certain moisture to it, e.g., 10 wt % moisture. The inputs may yield an output with various make-up and characteristics, as shown in FIG. 9. The make-up and characteristics of the syngas from the gasifier, and further after the oxyblown autothermal reformer may be provided.

### 2. Example

### Ammonia from Corn Cobs (23 wt % Moisture)

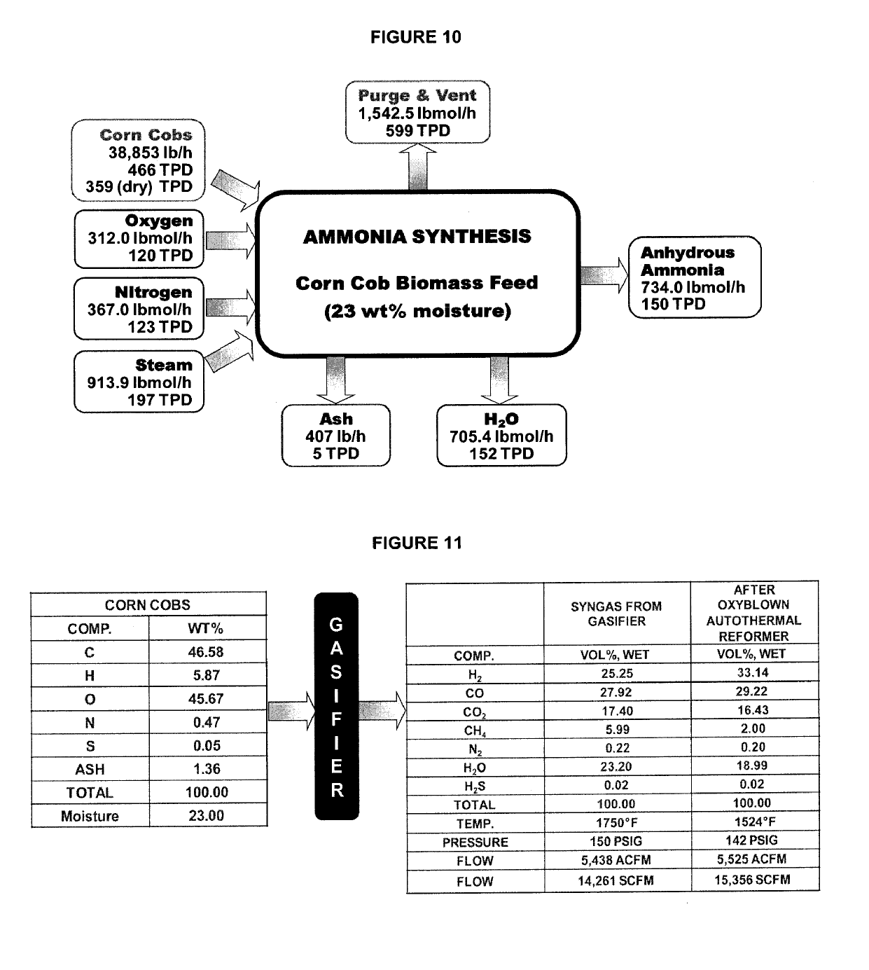

FIG. 10 shows an example of ammonia synthesis from a corn cob biomass feed with 23 wt % moisture. For example, corn cobs, oxygen, nitrogen, and steam may undergo ammonia synthesis and yield anhydrous ammonia, ash, water, and other items that may be purged and vented. The relative amounts of the products yielded may depend on the moisture of the biomass feed.

FIG. 11 shows an input and an output from a gasifier from a corn cob biomass feed with 23 wt % moisture. The make-up of the inputs to the gasifier may include carbon, hydrogen, oxygen, nitrogen, sulfur, and ash. The input may have a certain moisture to it, e.g., 23 wt % moisture. The inputs may yield an output with various make-up and characteristics, as shown in FIG. 11. The make-up and characteristics of the syngas from the gasifier, and further after the oxyblown autothermal reformer may be provided.

Design Criteria & Geometry

The following design criteria and geometry may be implemented in one embodiment and may be provided by way of example only. The criteria and geometry provided in the embodiment may also be approximate figures, and other figures may result in a substantially equivalent implementation. Other criteria and configurations may be used for other embodiments of the invention.
Biomass feed rate=384 tons per day=32,019 lbs/hr
Oxygen feed rate=105 tons per day=8,738 lbs/hr
Steam feed rate=271 tons per day=22,553 lbs/hr
Syngas produced=607 tons per day=50,551 lbs/hr
Fluidization velocity is calculated at gasifier temperature in that section
Maximum fluidization velocity in reactive & fluidization bed section=1 ft/sec
Maximum fluidization velocity in disengagement section=0.5 ft/sec
Oxygen jet velocity=100 ft/sec
Residence time=30 minutes minimum, assuming a bed density of 20 lb/ft3
Gas flow in the reaction section, actual cubic feet per second=20
Gas flow in the disengagement section, actual cubic feet per second=87
Height over diameter ratio in reactive & fluidized bed section=1
Height over diameter ratio in disengagement section=1.5
Calculated height and diameter of reactive section (3)=5′1″
Calculated height and diameter of fluidized bed section (4)=10′6″
Calculated diameter of disengagement section (5)=14′11″
Calculated height of disengagement section (5)=22′5″

Gasifier Drawing

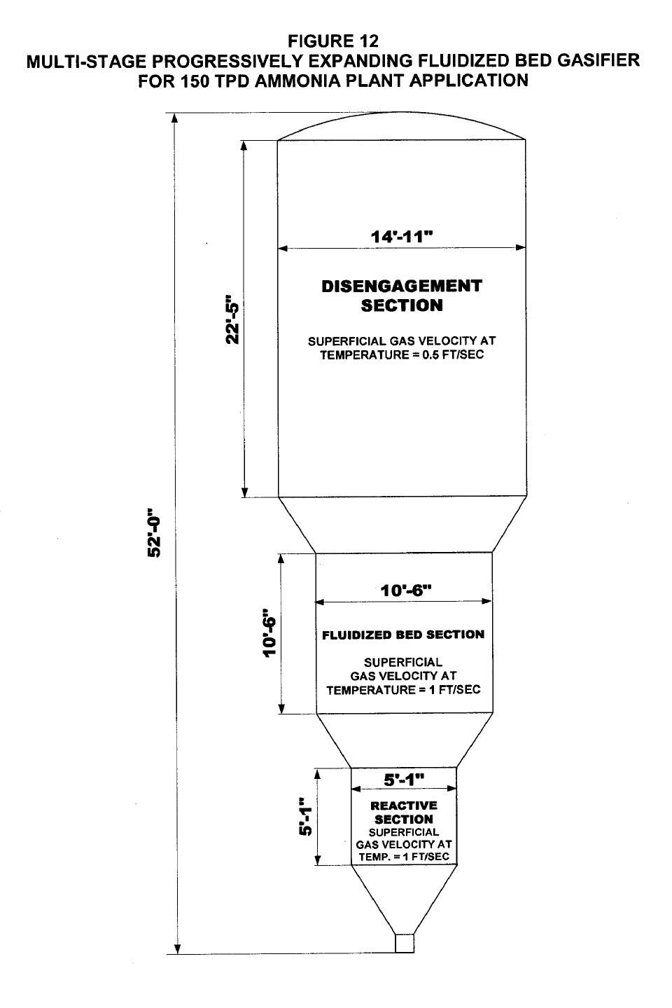

Based upon the information noted above, an outline drawing of the gasifier that may be used for the ammonia application is shown in FIG. 12. As discussed previously, the dimensions are provided in accordance with one embodiment of the invention, but may vary for other embodiments of the invention.

The gasifier may include a first stage, a second stage, and a third stage. The first stage may be a reactive section, and may be configured to receive a biomass feed and the oxygen, steam and/or carbon dioxide. The second stage may be a fluidized bed section, may have a greater cross sectional area than the first stage, and may be configured to receive the reaction products from the first stage, mix them and perform fluidized bed activity. In some instances, the second stage may include a fluidized bed media that may possess nascent catalytic activity to reform tars. The third stage may be a disengagement section, may have a greater cross sectional area than the second stage, and may be configured to receive the reaction products from the second stage and to separate fluidized media and particulate matter from syngas product.

In some embodiments, the first stage may have a lesser height and/or diameter than the second stage, and the second stage may have a lesser height and/or diameter than the third stage. In some instances, the height and diameter of the first stage may be substantially the same or may be different, second stage may be substantially the same or may be different, and/or third stage may be substantially the same or may be different.

Any components, features, characteristics, or steps known in the art may be utilized in the gasifier, systems, and/or methods. See, e.g., U.S. Pat. No. 4,597,771; U.S. Pat. No. 5,868,082; U.S. Pat. No. 4,526,903, and U.S. Pat. No. 5,620,487; which are hereby incorporated by reference in their entirety.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A pressurized fluidized bed gasifier comprising:
plurality of stages wherein a subsequent stage is in fluid communication with a previous stage and has a greater cross-sectional area than the previous stage;
a feed inlet configured to transfer a biomass feed to a stage;
an outlet configured to receive syngas from one or more stage downstream of the stage receiving the biomass feed.

2. The gasifier of claim 1, wherein the syngas is used to make an ammonia product that meets all the accepted standards for classification as an organic fertilizer.

3. The gasifier of claim 1, further comprising one or more outlet for a biochar product.

4. The gasifier of claim 1, further comprising one or more outlet for a biochar that is used to produce a soil conditioning agent that is a mixture of the biochar and inorganic ash residues.

5. A biomass gasification system, comprising:
the gasifier of claim 1; and
a cryogenic air separation unit, wherein nitrogen is produced as a byproduct from the cryogenic air separation unit.

6. The system of claim 5 wherein the nitrogen produced from the air separation unit is combined with hydrogen produced from the gasifier for the manufacturing of anhydrous ammonia.

7. The system of claim 5 wherein the cryogenic air separation unit provides oxygen to the gasifier.

8. A pressurized gasifier, with or without fluidizing media, comprising:
a first stage configured to receive a biomass feed and an oxygen, steam and/or carbon dioxide feed;
a second stage with a greater cross sectional area than the first stage configured to receive the reaction products from the first stage, mix them and perform fluidized bed activity; and
a third stage with a greater cross section area than the second stage configured to receive the reaction products from the second stage and to separate fluidized media and particulate matter from syngas product.

9. The gasifier of claim 8 wherein the second stage includes a fluidized bed media that possesses nascent catalytic activity to reform tars and/or volatiles.

10. The gasifier of claim 8 wherein methane production the syngas is reduced by 85% or more.

11. The gasifier of claim 8 configured to operate in a pressure range of 15-300 psig.

12. The gasifier of claim 8 that generates an end product with a H₂/CO molar ratio within the range of 0.75 and 2.5.

13. The gasifier of claim 12 wherein the end product is a gas mixture with compositions suitable for the downstream production of dimethylether (DME), ethanol, or butanol.

14. The gasifier of claim 8 further comprising a bubbling bed of material configured to crack tar components.

15. A biomass gasification system, comprising:
the gasifier of claim 8; and
an oxyblown catalytic autothermal reactor downstream of the gasifier, said oxyblown catalytic autothermal reactor configured to reform residual tars, volatiles and methane.

16. A pressurized gasifier comprising:
a reaction stage; and
a biomass feed line configured to deliver a biomass feed to a low and centralized region of the reaction stage.

17. The gasifier of claim 16 wherein the biomass feed line enters the reaction stage through the wall of the reaction stage

18. The gasifier of claim 16 wherein the biomass feed line is angled downward to deliver the biomass feed.

19. The gasifier of claim 16, further comprising an oxygen feed that is annularly encased within the steam supply line, wherein an oxygen jet point is surrounded by a steam shroud that contains and stabilizes an oxygen flame from the oxygen jet point.

20. The gasifier of claim 16, wherein said gasifier does not require any other external supplies of energy in its operation other than inherent energy of its feedstock.

21. A biomass gasification system comprising:
the gasifier of claim 16;
oxyblown catalytic autothermal reactor downstream of the gasifier; and
a cryogenic air separation unit that simultaneously provides oxygen into the gasifier and into the oxyblown catalytic autothermal reactor.

22. The gasifier of claim 16 wherein the feed apparatus receives elemental sulfur, which is converted into hydrogen sulfide in the gasifier.

23. The gasifier of claim 22 further comprising an outlet configured to receive a syngas product from at least one stage downstream of the reaction stage.

24. The gasifier of claim 23 wherein hydrogen sulfide levels of the syngas product range from 300 ppm to 1,000 ppm.
